(19) United States
(12) Patent Application Publication
(10) Pub. No.: US 2004/0236495 A1
(43) Pub. Date: Nov. 25, 2004

(54) Data analysis system

(76) Inventors: Robert Koenen, Pewaukee, WI (US); Scott Wesenberg, Hartland, WI (US); Thomas D. Fredrickson, New Berlin, WI (US); Vincent Shiely, Brookfield, WI (US); Michael Plutte, Oak Creek, WI (US)

Correspondence Address: Casimir F. Laska, Michael Best & Friedrich LLP, 100 East Wisconsin Avenue, Milwaukee, WA, 53202-4108, US

(21) Appl. No.: 10/443,581

(22) Filed: May 22, 2003

(51) Int. Cl. G06G 7/70

(52) U.S. Cl. 701/114; 701/115; 324/402

(57) ABSTRACT

A data acquisition module for collecting data from engine-driven power equipment. The module records the operational characteristics of the power equipment. The module stores historical operational data such as time of use, total operational time, load, speed, etc. The module also provides information to the user when service or maintenance is due to be performed.

### FIELD OF THE INVENTION

The present invention relates to a data analysis system for outdoor power equipment that acquires and analyzes machine operating data.

### BACKGROUND OF THE INVENTION

There are many types of outdoor power equipment. Outdoor power equipment, such as lawn mowers, generators, and pressure washers, is typically designed and manufactured for either residential or commercial applications. Generally, equipment designed and manufactured for a residential application should not be used in a commercial application due to possible design limitations.

Knowing the operational characteristics of the outdoor power equipment is important to determine when to service the equipment, to diagnose problems, and monitor the equipment's performance. An outdoor power equipment user may or may not regularly service the equipment, i.e., change the oil, air filter, and spark plugs. In addition, a user may use equipment designed for residential applications in a commercial application, thereby causing more wear and tear than the equipment is designed to handle.

Outdoor power equipment owners often do not perform their own repairs on the equipment when the equipment stops working or it is not working properly. Rather, the owners may take the equipment to a repair shop where the mechanic typically listens to the owner's description of the problem or apparent problem with the equipment. The mechanic may try to operate the equipment to listen to the engine to diagnose the problem, but most often, the problem cannot be directly diagnosed and the equipment must be taken apart to diagnose the problem. Taking apart the equipment wastes a lot of time.

Alternatively, when the equipment is inoperable or is not working properly, the user may approach the manufacturer for a replacement or repairs because the equipment is under warranty. Manufacturers typically replace or repair equipment under warranty agreements if the equipment is inoperable or requires repairs before its warranty period expires. In many cases, the manufacturer is unable to determine whether the equipment was misused or not properly maintained, leaving the manufacturer with higher than expected warranty replacement costs.

Equipment rental shops typically rent outdoor power equipment to renters that need to use a piece of equipment for a short period of time. When the equipment is returned, the rental shop needs to determine how long the equipment was in operation and how it was used. This information allows the rental shop to determine when the equipment needs servicing and maintenance. However, keeping track of the total operation time of the equipment and a schedule of servicing the equipment is a challenge and a difficult task for many rental shops.

In addition, because it is a difficult task to track total operation time and servicing and maintenance needs, the equipment may not receive regular servicing and maintenance. As a result, the equipment may not operate upon arrival at the renter's desired location. In these circumstances, the renter may have to return to the rental shop for a replacement.

### SUMMARY OF THE INVENTION

The present invention records the operational characteristics of outdoor power equipment. The device stores historical operational data such as time of use, total operational time, load, speed, etc. The device also provides information to the user when service or maintenance is due to be performed. It may be used as a tuning device to adjust certain operational components to obtain optimal performance of the equipment. The invention may be retrofitted onto existing outdoor power equipment and installed by the user. Or, the invention may be installed onto the outdoor power equipment by the manufacturer.

One embodiment of the present invention includes a data acquisition module for collecting data from engine-driven power equipment. The equipment includes an engine having a spark plug and a spark plug wire. The module includes a housing, a sensor, an analog-to-digital (A/D) converter, and a storage device. The sensor is operable to sense an analog signal functionally related to a spark plug ignition signal. The storage device is operable to store data corresponding to the digital signal generated by the A/D converter.

Another embodiment of the present invention is directed to a system that determines operational characteristics of outdoor power equipment. The equipment includes an engine having a spark plug and a spark plug wire. The system includes a data acquisition module and a remote computer device. The data acquisition module includes a housing, a sensor, an A/D converter, and a storage device. The remote computer device includes a computer program operable to communicate with the data acquisition module.

Another embodiment of the present invention is directed to outdoor power equipment including an engine, and a data acquisition module. The engine includes a spark plug and a spark plug wire. The data acquisition module includes a housing, a sensor, an A/D converter, and a storage device.

### BRIEF DESCRIPTION OF THE DRAWINGS

FIG. 1 is a perspective view of an exemplary lawnmower, including a data acquisition module according to the present invention.

FIG. 2 is a perspective view of an engine assembly of the exemplary lawnmower.

FIG. 3 is a perspective view of an electrical generator, including a data acquisition module according to the present invention.

FIG. 4 is a perspective view of an embodiment of the data acquisition module.

FIG. 5 is a schematic diagram illustrating the circuit of the data acquisition module.

FIG. 6 is a perspective view of an exemplary remote personal computer.

FIG. 7 is a perspective view of an exemplary remote personal digital assistant (PDA).

FIG. 8 is an exemplary flow chart of the operation of the data acquisition module.

FIG. 9 is an exemplary flow chart of the operation of a software program resident on a remote computing device.

FIG. 10 is a screen display of the software program displaying historical operational data.

FIG. 11 is a screen display of the software program displaying maintenance data.

FIG. 12 is another screen display of the software program displaying maintenance data.

FIG. 13 is another screen display of the software program displaying operational data as a graphical representation.

Before one embodiment of the invention is explained in detail it is to be understood that the invention is not limited in its application to the details of the construction and the arrangements of the components set forth in the following description or illustrated in the drawings. The invention is capable of other embodiments and of being practiced or carried out in various ways. Also, it is understood that the phraseology and terminology used herein is for the purpose of description and should not be regarded as limiting. The use of “including” and “comprising” and variations thereof herein is meant to encompass the items listed thereafter and equivalents thereof as well as additional items.

### DETAILED DESCRIPTION

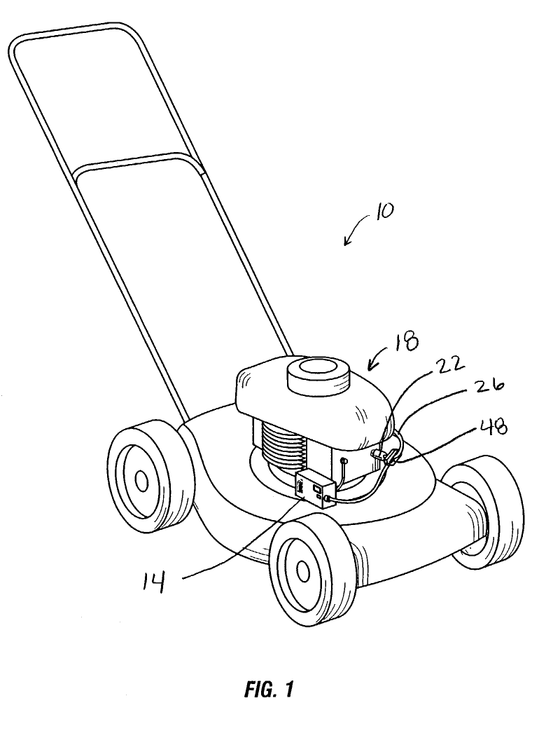

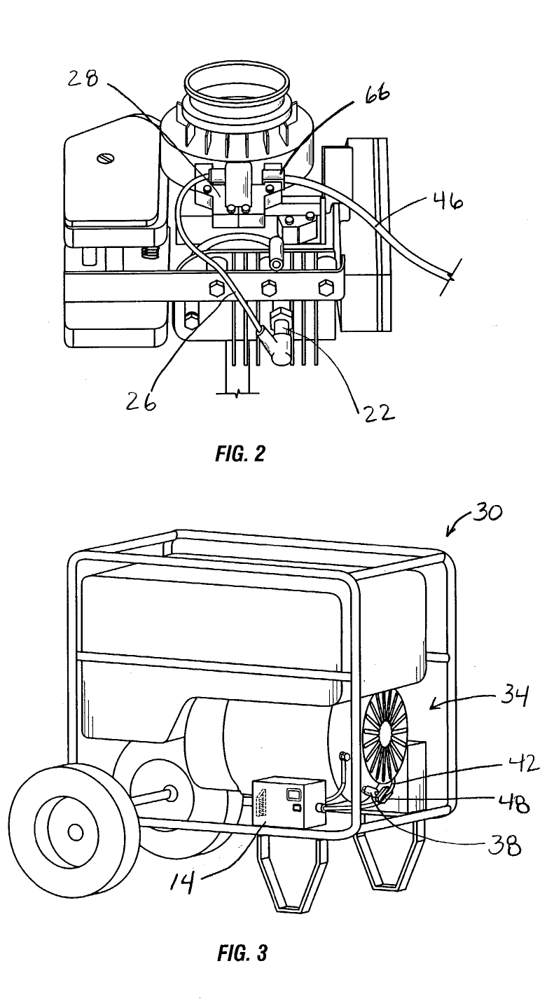

FIG. 1 illustrates a lawnmower 10 including a data acquisition module 14. The type of lawnmower could be a walk-behind, a riding lawnmower, or any other type of engine-driven equipment. The lawnmower 10 includes an engine assembly 18 (illustrated in more detail in FIG. 2). The engine assembly 18 includes, among other things, a spark plug 22 that receives an ignition signal, a spark plug wire 26, and an ignition coil 28 (illustrated in FIG. 2).

The data acquisition module 14 is supported on the deck or blower housing of the lawnmower 10. However, the data acquisition module 14 could be supported in any suitable location on the lawnmower 10, i.e., on the handle assembly. The data acquisition module 14 could be removably attached to the lawnmower 10 with any type of fastener, such as, hook-and-loop, screws, nuts, bolts, tape, or any other type of fastening mechanism. The data acquisition module 14 could also be permanently attached to the lawnmower 10.

FIG. 3 illustrates an electrical generator 30 including the data acquisition module 14. The generator 30 includes an engine assembly 34. The generator engine assembly 34 includes, among other things, a spark plug 38 that receives an ignition signal and a spark plug wire 42. The data acquisition module 14 is supported in any suitable location, e.g., frame, on the engine, or on the alternator, and could be removably attached or permanently attached to the generator 30. The remainder of the detailed description will refer to the component numerals of the lawnmower 10. However, it should be noted that the detailed description should not be limited to the lawnmower application, but could apply to any engine-driven power equipment where storage of operational characteristics is desired.

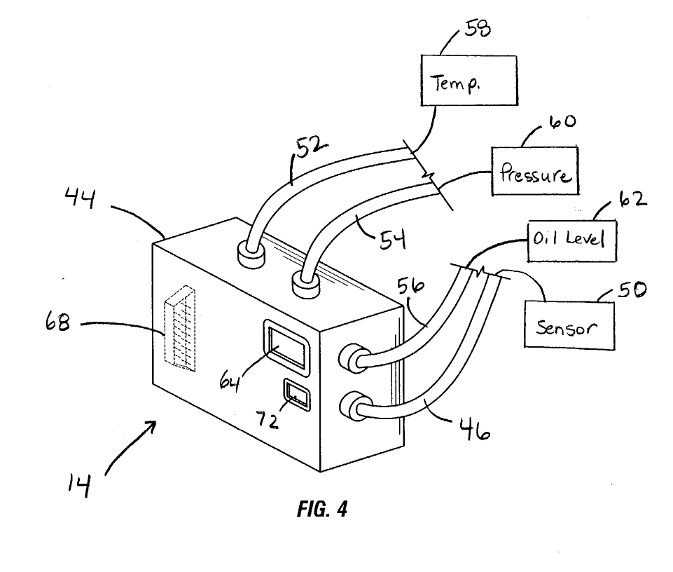

Referring to FIG. 4, the data acquisition module 14 includes a housing 44 and a wire 46 that extends out of the data acquisition module 14 and removably connects to the spark plug wire 26. The wire 46 includes a connector 48 (shown in FIG. 1) on the distal end of the wire 46 and a sensor 50. The connector 48 may be connected to the spark plug wire 26 or spark plug 22 in any suitable manner to sense an ignition signal. The connector 48 may be an alligator type that clips onto the spark plug wire 26, or a rubber coated wire loop which slips over the exposed portion of the spark plug 22 to sense an ignition signal. The wire loop acts as the sensor and the rubber coating holds the wire loop on the spark plug 22. The rubber coating allows the wire loop to remain still on the spark plug 22 during vibrations caused when the lawnmower 10 is running. Alternatively, the wire 46 may include an inductive sensor 66 (illustrated in FIG. 2), i.e., hall effect sensor, that is connected to or positioned near the ignition coil 28 to sense an ignition signal. If the inductive sensor 66 is connected to the ignition coil 28, the ignition signal may be sensed anywhere on the ignition coil 28. The module 14 may also include other wires 52, 54, and 56 and sensors 58, 60, and 62 to sense engine temperature, pressure, and oil level, respectively.

The data acquisition module 14 includes a data port window 64 and a serial port interface connector 68 to communicate with other computerized devices (discussed below). The module 14 also includes an indicator window 72 that indicates whether the engine 18 is operating.

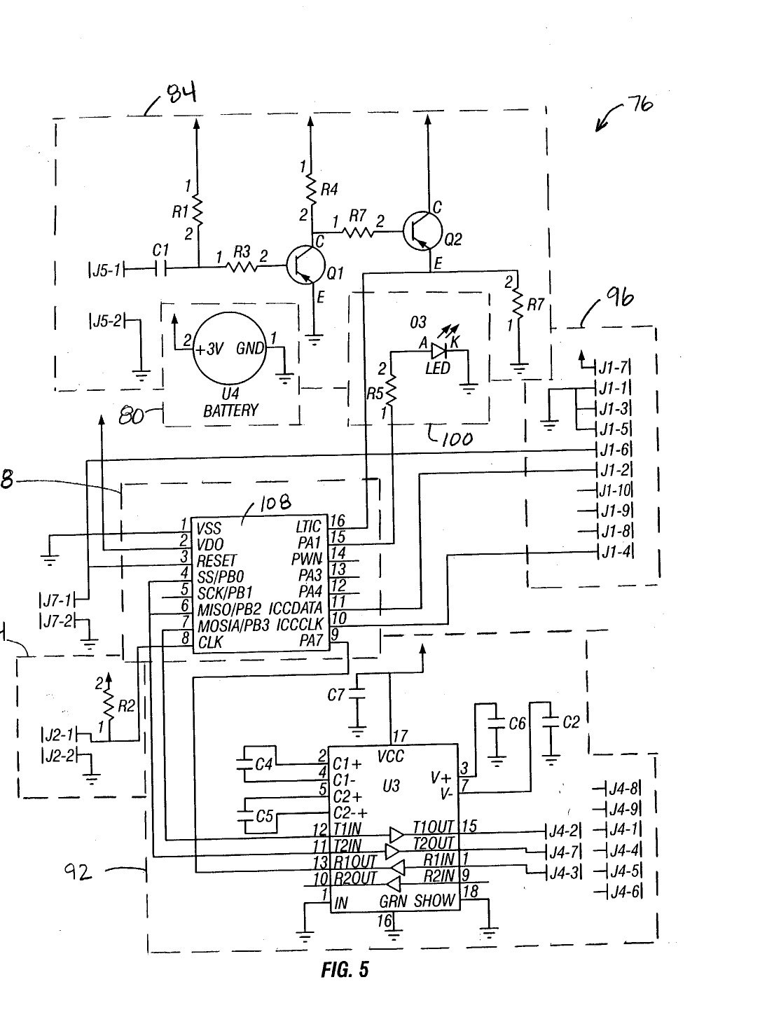

The module 14 includes an electronic circuit 76 illustrated in FIG. 5. The circuit 76 is supported in the housing 44. The circuit 76 includes a battery 80, an analog signal acquisition and filter circuit 84, an analog to digital (A/D) conversion circuit 88, a serial interface circuit 92, a programming header circuit 96, and an engine operating circuit 100. The circuit 76 may include a temperature sensor circuit 104 and other circuits (not shown) to detect signals from other sensors, i.e., sensors to detect air-to-fuel ratio, oil quality, throttle position, and intake vacuum pressure.

The battery 80 provides power to the circuit 76. In the preferred embodiment, the battery 80 is a lithium type battery. When the engine 18 is running, the engine operating circuit 100 receives power to activate a flashing light emitting diode (“LED”). The LED flashes a light that is visible through the indicator window 72 on the module 14 to inform the user that the engine 18 is running and the module 14 is sensing the ignition signal. The LED may be an ordinary non-flashing LED.

The wire 46 senses an ignition signal from the spark plug wire 26 and transmits the signal to the analog signal acquisition and filter circuit 84. The ignition signal is filtered and transmitted to the A/D conversion circuit 88, which includes microprocessor 108. A suitable microprocessor 108 is ST7FLite09, manufactured by ST Micro. The microprocessor 108 converts the analog ignition signal to a digital signal and stores the digital signal in memory in the microprocessor 108. For each ignition signal, the microprocessor 108 converts the analog signal and stores a digital signal that is functionally related to the spark plug ignition signal.

The microprocessor 108 also computes and stores various operational values of the engine 18 based on the stored digital signals. The microprocessor 108 stores an index/cycle number, the number of times the engine has been used, the length of time the engine was running during each use, the maximum and average load during each use, the maximum and average speed of the engine during each use, and the total time for all uses of the engine.

The load and speed values are calculated using an intra-cyclic speed variation method, which measures the load based on the difference between firings of the power stroke and the exhaust stroke of the engine 18. This load calculation method is discussed in U.S. Pat. No. 5,445,014 issued Aug. 29, 1995 and assigned to Briggs & Stratton Corporation, and is incorporated herein by reference. The operational values are also stored in the microprocessor 108 when the engine 18 is not operating. The microprocessor 108 could also compute and store other operational values of the engine, such as temperature and pressure. The operational values are stored preferably after the engine has been running for one minute. The microprocessor 108 is also capable of storing a module identifier, i.e., module name, such as Lawnmower #1, that is transmitted from the remote computing device.

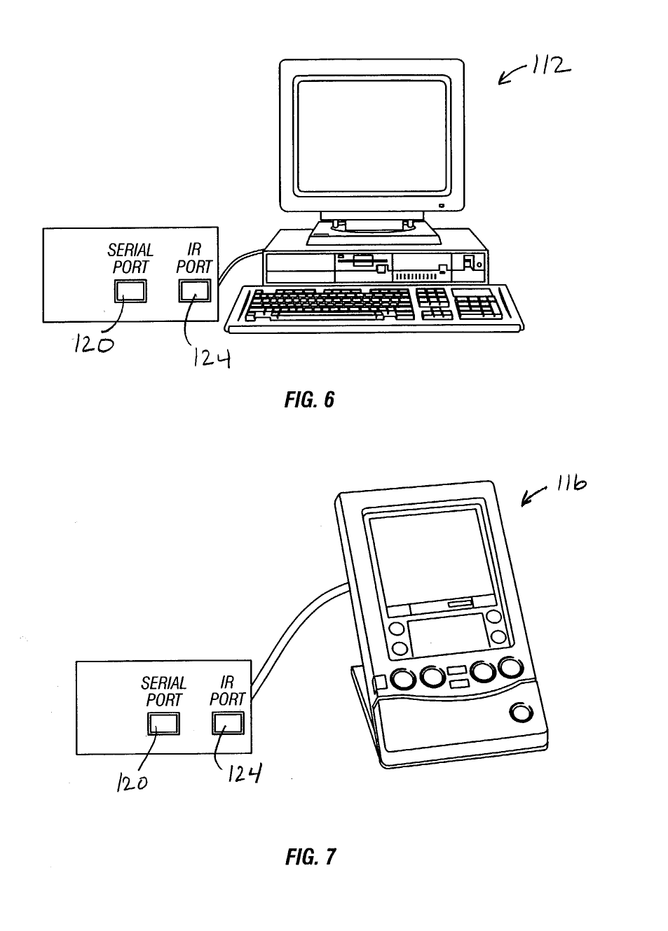

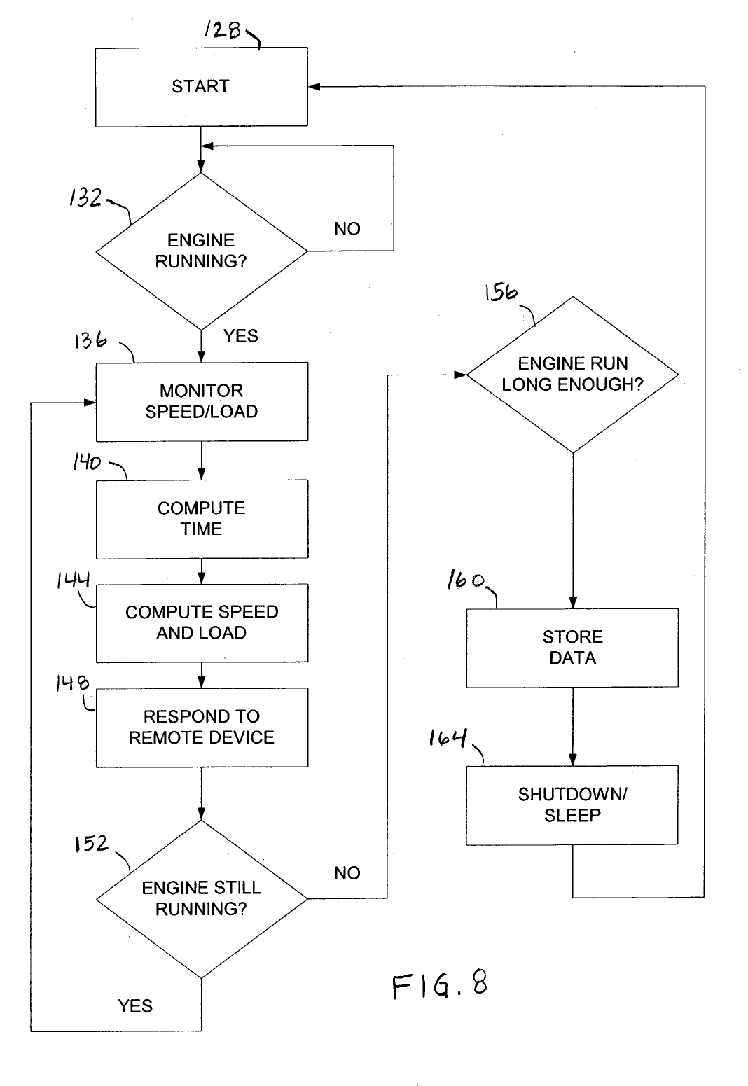

The serial interface circuit 92 translates the stored digital signals from a lower voltage signal to a higher voltage signal. A suitable RS 232 serial converter IC is a Maxim MAX3222. A serial interface cable (not shown) may be connected to the serial port interface connector 68 on the module 14 to download the stored operational values to a remote computer device illustrated in FIGS. 6 and 7. The remote computer device may be a desktop computer 112, a laptop, a personal display assistant 116, wireless device, cell phone or any other computing device. The remote computing devices preferably include a serial port 120 and an infrared port 124. The remote computing devices generally include standard input and output devices such as a mouse, modem, keyboard, printer, magnetic and optical storing devices, and a display. Of course, the devices could include a host of technologically advanced input and output devices such as voice recognition devices, biometric devices, etc.

FIG. 8 illustrates a flow chart of the operation of the module 14. At step 128, upon startup, the module checks to verify that the engine 18 is running at step 132. If the engine 18 is running, for each sensed ignition signal, the microprocessor 108 monitors the speed of the engine 18 and the load applied to the engine 18 at step 136. The microprocessor 108 determines the time the signal is sensed and calculates the time difference between two sensed signals. This value is the period and the speed value. The load is calculated by subtracting two speed values. At step 140, the microprocessor 108 computes the time the engine 18 has been running. At step 144, the microprocessor 108 computes the average and maximum speed and load operational values. In the preferred embodiment, the average is computed by adding 255 speed values and dividing by 255. It then starts a new summation with one value, which is the average value of the previous 255 values.

The circuit 76 then checks if it needs to respond to a remote device at step 148. If a serial cable is connected to the serial port interface connector 68 of the module 14 and the serial port 120 of the remote device 112, 116 then the stored information in the module 14 is downloaded to the remote computer device 112, 116 (discussed below).

Alternatively, if the data port window 64 of the module 14 is within an adequate distance to communicate with the infrared port 124 of the computing device 112, 116, then communication can be initiated between the module 14 and the computing device 112, 116, such that the stored information in the module 14 is downloaded to the computing device 112, 116. At step 152, if the engine 18 is still running, the process returns to step 136 to monitor and compute operational values based on the next sequential ignition signal. If the engine 18 is no longer running, the circuit 76 determines whether the engine was running for a predetermined threshold duration at step 156. In the preferred embodiment, the predetermined threshold is one minute. If the engine 18 was running for the predetermined threshold, the operational values are stored in the microprocessor 108 at step 160. If the engine 18 was running for less than the predetermined threshold, the operational values are not stored and the module 14 is shutdown at step 164.

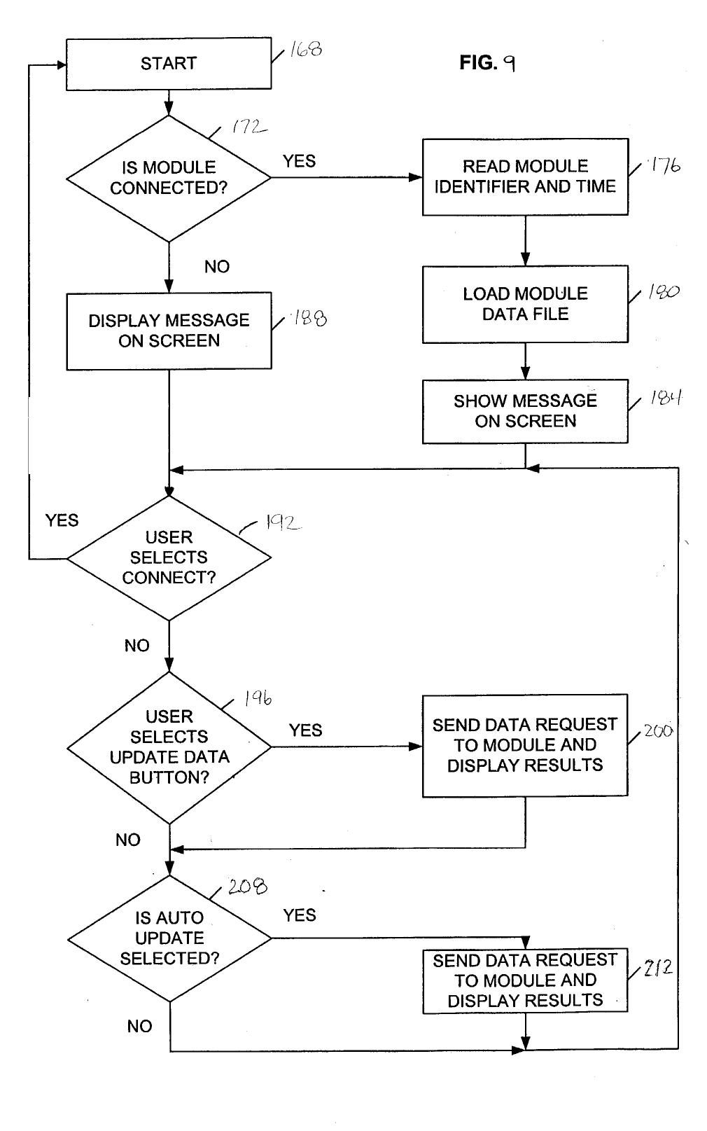

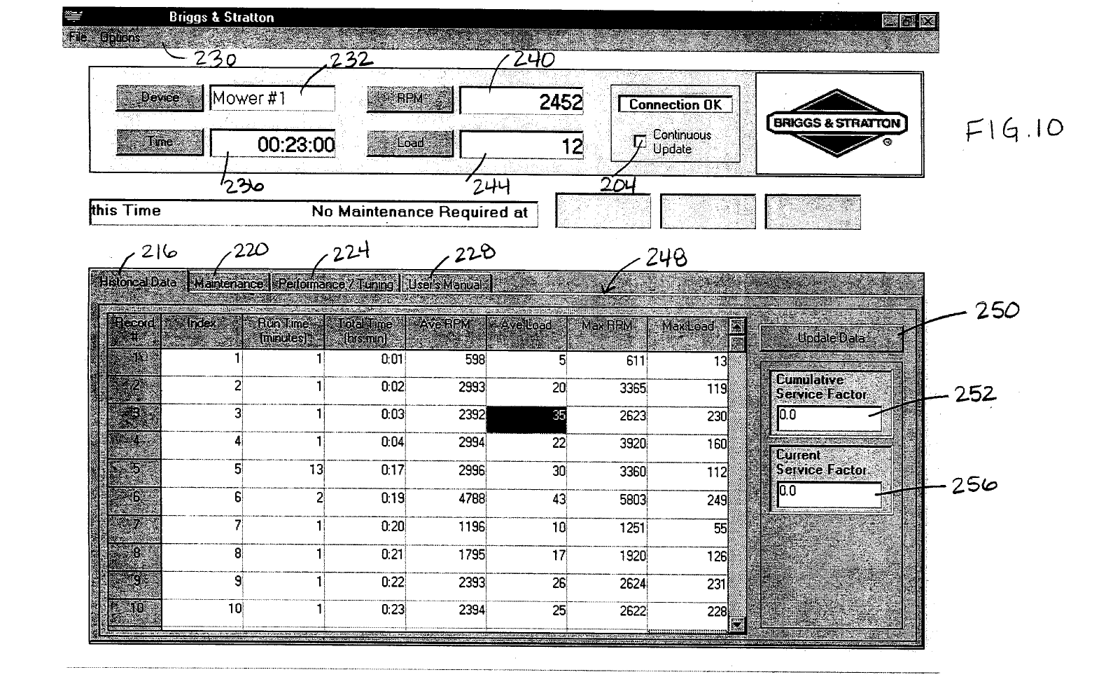

If a serial cable is connected to the serial port interface connector 68, communication with the remote computing device 112, 116 is initiated. FIG. 9 illustrates a flow chart of the operation of the remote computing device 112, 116 and resident software program. At step 168, upon startup, the remote computing device 112, 116 checks to determine whether the module 14 is connected to the serial cable at step 172. If the module 14 is connected to the serial cable, the remote computing device 112, 116 receives and reads the module identifier and the running time data at step 176.

In step 180, if a data file has been generated and stored in the computer 112, 116 hard drive, the file is loaded and transmitted or imported to the module 14. The data file may include the module identifier that is to be stored in the module 14. Other data files could also be generated and transmitted to the module 14 to be stored in the module 14. The computing device monitor displays an indication whether the connection with the module 14 is adequate or whether there is no connection with the module 14 at steps 184 and 188, respectively.

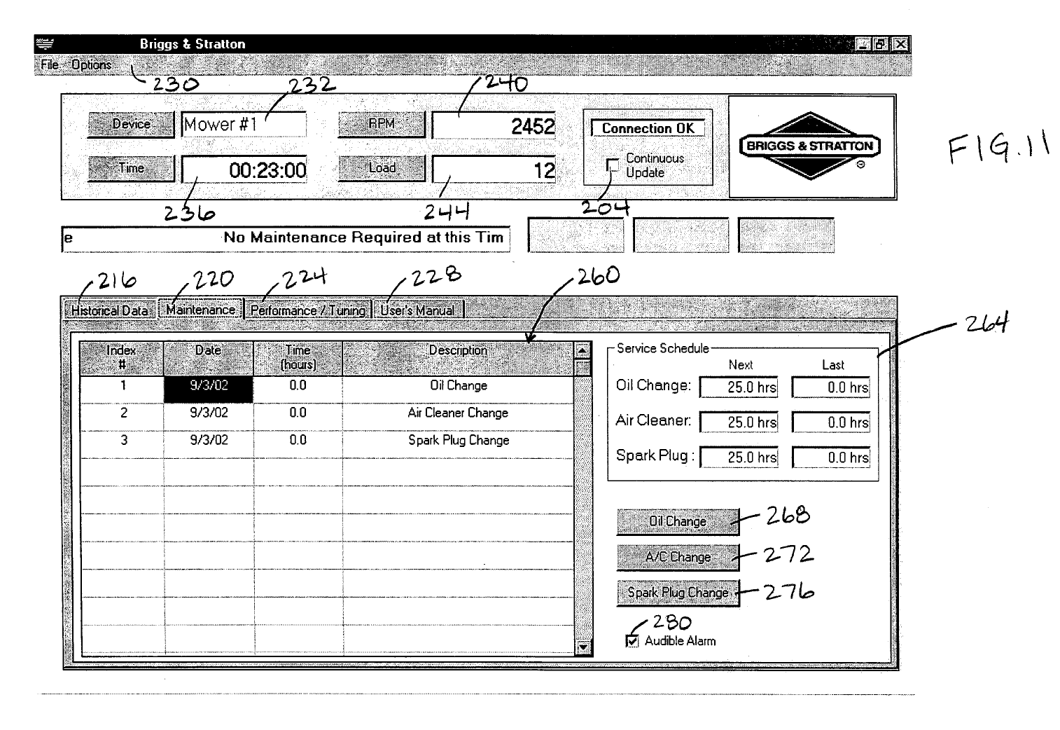

If the module 14 is not connected or the module 14 loses connection with the remote computing device 112, 116, the display indicates that there is “no connection” or a similar message. Upon seeing this message, at step 192, the user accesses a main menu 230 by clicking on Options (shown in FIG. 10), or equivalent, to display a menu of selections (not shown). A pull-down menu appears on the display and allows the user to select a connect option to establish or reestablish communication with the module 14. This feature allows the user to check the cable connections and to establish or reestablish communication between the module 14 and the remote computing device 112, 116 and corresponding software program(s) without having to exit the software program. If the user selects the connect option at step 192, the software program returns to step 168 to determine whether a connection has been established as determined at steps 184 and 188.

After establishing a connection, the user clicks on an Update Data button 250 (shown in FIG. 10), at step 196, on the screen or uses the mouse to select a button to upload the stored data in the module 14 or to access other portions of the software program. If the user selects the button 250 to upload the stored data, the software program communicates with the module 14 through the serial port interface circuit 92 to request the stored data at step 200. The stored data is displayed on the monitor, as illustrated in FIG. 10 (discussed below). As illustrated in FIG. 10, a Continuous Update selection box 204 is provided to the user so the computer program will continuously request the speed, load, and the time data stored in the module 14.

Referring back to FIG. 9, at step 208, the computer program checks to determine whether the Continuous Update selection box 204 is marked. If the box 204 is marked, the computer program will continuously request the stored data in the module 14 at step 212. If the box 204 is not marked, the computer program does not request additional stored data from the module 14 and returns to the point just before step 192.

During the connection process, the user may also access the main menu 230 to select the particular serial port 120 and associated communication speed between the module 14 and the remote computing device 112, 116.

FIG. 10 illustrates a screen displayed on the monitor when the user uploads the stored data in the module 14. The screen may include, but is not limited to fields, dialog boxes, tabs, buttons, radio buttons, and drop down menus. Field titles may vary and are not limited to that shown in the drawings. The screen includes several tabs 216, 220, 224, and 228. Tab 216 illustrates the uploaded historical data from the module 14. Tab 220 illustrates the maintenance that has been performed and when maintenance is due. Tab 224 illustrates graphical data for tuning the engine 18. Tab 228 provides access to the user's manual for the equipment and the software program.

The content for the screen associated with tab 216 is displayed in FIG. 10. The module identifier is indicated at box 232. The total running time for all cycles is indicated at box 236. The speed value is indicated at box 240. The load value is indicated at box 244. Since the Continuous Update selection box 204 is marked, the total running time box 236, speed value box 240, and load value box 244 are continuously updated as the computer program receives the stored data from the module 14. The data also appears in a historical data section 248. The historical data section 248 indicates the index or use number, the length of time the engine 18 was running during the use, the total cumulative running time of the engine 18, the average speed and load during the use, and the maximum speed and load during the use. The data may also be stored in the computer hard drive.

A cumulative service factor 252 is a number or indication to the user that determines whether the engine 18 needs servicing or maintenance, i.e., oil change, air filter change, or sparkplug replacement. This factor is based on the load, speed, and running times. This factor is useful because it is based on the user's actual use of the engine 18, rather than on the average person's use of the engine 18 as indicated in the user's manual. The factor may be determined by multiplying the average speed, the average load, and the total running time.

A current service factor 256 is a number or indication to the user that determines whether the engine 18 needs servicing or maintenance based on the past 25-50 hours of running time or any other suitable range. This factor assists in determining whether the engine 18 has been used more frequently within a short period of time, for example, during the summer months, and requires maintenance earlier than the average use.

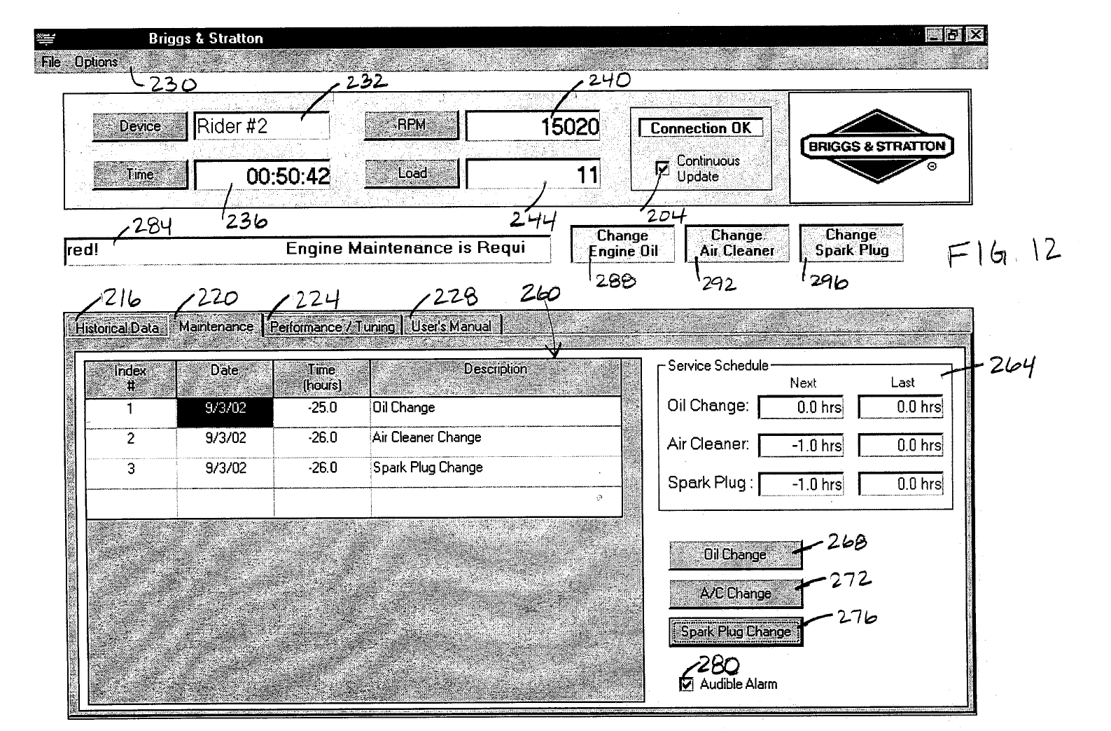

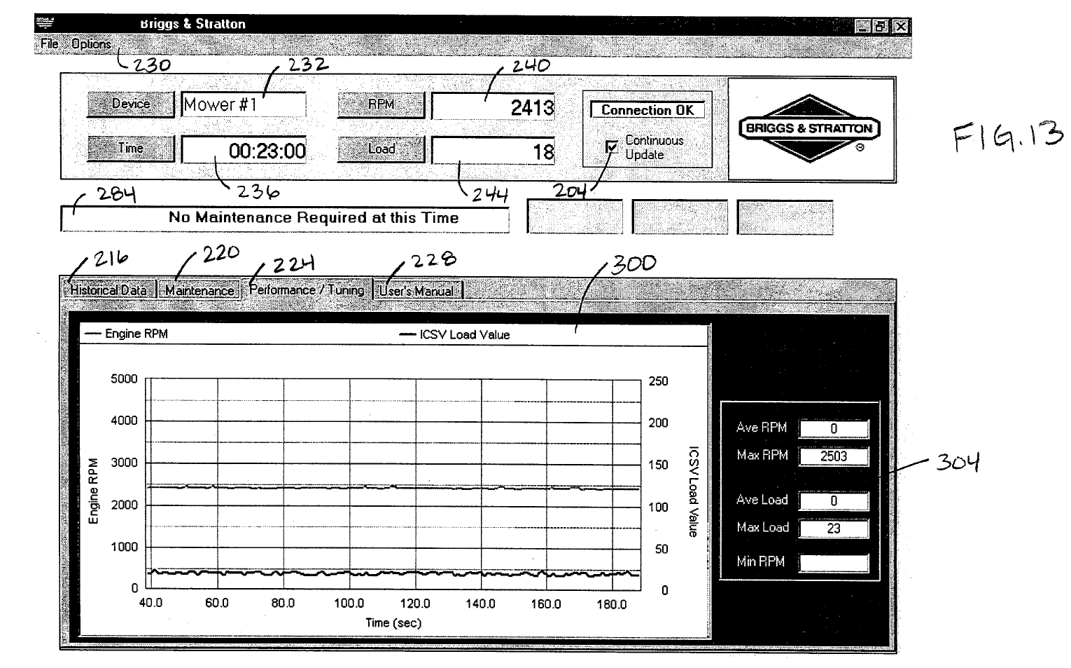

FIGS. 11 and 12 illustrate screens for the maintenance tab 220. In FIG. 11, a maintenance performed section 260 indicates when maintenance was performed on the engine 18. The date, the time based on the total running time, and a description is provided. A service schedule section 264 indicates the time when the maintenance was performed and when maintenance is next due based on the total running time. An oil change button 268 is provided for the user to select or click for updating data for each oil change performed. The data is stored for a history of all oil changes. An air cleaner change button 272 and a spark plug change button 276 are also provided to update data for each air cleaner and spark plug change performed. An audible alarm selection box 280 is provided so the user can activate an audible alarm when maintenance is past due.

FIG. 12 illustrates an alarm condition for past due maintenance. A message box 242 indicates that engine maintenance is required. Additional message boxes 288, 292, and 296 indicate the specific maintenance that is overdue, e.g., oil, air cleaner, and spark plug. The boxes 288-296 could also be colored to represent how long the maintenance is overdue, i.e., red means 5 hours overdue, yellow means 3 hours overdue. The boxes 288-296 could also flash to get the user's attention. Any other means available could be used to get the user's attention. After the user updates the data in the maintenance performed section 260 or adjusts the data in the service schedule section 264, the messages will be removed from the display.

A graphical representation is illustrated in FIG. 13. A graphical representation section 300 of speed and load versus time is provided in the performance/tuning tab 224. The graphical representation is updated while the stored data in the module 14 is uploaded to the computing device 112, 116. The average speed and load values, maximum speed and load values, and the minimum speed value are displayed in an operational data section 304. Additionally, the user may access the performance/tuning tab 224 while the engine 18 is running to adjust the engine components to modify the engine's operation or to obtain optimal engine performance.

As can be seen from the above, the invention provides a device for calculating, recording, and storing the operational characteristics of outdoor power equipment. The invention may be used by an average user by connecting a serial cable between the serial port 120 of the computing device 112, 116 to the serial port 68 of the module 14. The module 14 may remain on the lawnmower 10 or the module 14 may be removed from the lawnmower 10 to connect to the computing device 112, 116 at a more convenient location.

The computing device 112, 116 communicates with the module 14 to receive the stored operational data from the module 14. Alternatively, the average user may point the computing device 116 toward the infrared data port 64 on the module 14 to initiate wireless communication with the module 14. The computer program resident on the computing device 112, 116 operates to display the operational data on the screen to provide the user with the operational information of the lawnmower 10. The operational data displayed on the screen may be the stored historical data or real-time data, i.e., while the lawnmower 10 is running. The computer program may also be used to inform the user when maintenance is due based on preset criteria selected by the user.

The invention may be used by an advanced user that is knowledgeable and/or interested in tuning the lawnmower 10 for optimal or high performance. While the lawnmower 10 is running, the module 14 may be connected to the serial cable or wirelessly to the computing device 112, 116. While the lawnmower 10 is running, the computer program continuously updates the screen illustrating the operational data such that the advanced user can adjust or tune certain parts that affect the lawnmower's performance and view the effects of the adjustments on the screen as they are being made.

The invention may be used by a rental shop to keep track of the historical use of the lawnmower 10, or other engine-driven power equipment. The rental shop may track the equipment by assigning each piece an identifier that is downloaded into the module 14. The rental shop can track the amount of time the equipment was used by transmitting the information stored in the module 14 to the computing device 112, 116. The rental shop can also determine how the equipment was used, i.e., what load was applied, by viewing the stored operational data on the computing device 112, 116. By considering how the equipment was used and the length of time the equipment was used, the rental shop can properly maintain and service the equipment for optimal performance.

The rental shop may be able to develop new pricing plans based on time-of-use, rather than charging a flat fee for use of the equipment over a specified period of time. The rental shop may set alarms to warn it to change the oil, air cleaner, spark plug, or other maintenance needs on the equipment based on the amount of time the equipment was used rather than choosing an arbitrary time to provide maintenance. The rental shop may review the operational data to anticipate and replace wearable parts such that there are fewer equipment breakdowns while at the renter's location. In addition, the rental shop may use the equipment specifications and parts list stored in the computer program to assist in ordering parts and performing service.

The invention may be used by an equipment manufacturer to review the operational information over a period of time to determine how often the equipment was used and in what manner it was used. The manufacturer can review the historical operational information by transmitting the information stored in the module 14 to the computing device 112, 116. Based on the operational information i.e., the load values and length of time of each use, as viewed on the display of the computing device 112, 116, the manufacturer may be able to determine if the equipment was used in a non-recommended application, i.e., using a residential lawnmower in a commercial application. The operational data may indicate a long period of time for each use and an indication that the load was larger than expected when compared to the load if the equipment were used in a recommended application. If the equipment was used in a non-recommended manner or in violation of the equipment warranty, the manufacturer may not have to replace the equipment, and it may be able to reduce its warranty replacement costs.

Various features and advantages are set forth in the following claims.

What is claimed is:

1. A data acquisition module for collecting data from engine-driven equipment, the equipment including an engine having a spark plug and a spark plug wire, the module comprising:
a housing supportable on the equipment;
a sensor operable to sense an analog signal functionally related to a spark plug ignition signal;
an analog to digital (A/D) converter that converts the analog signal to a digital signal; and
a storage device that stores data corresponding to the digital signal.

2. The module as claimed in claim 1, further comprising a processor that computes an operation value of the equipment based on the digital signal.

3. The module as claimed in claim 2, wherein the operational value includes one of a speed value and a load value.

4. The module as claimed in claim 1, wherein the sensor includes a connector that is removably connectable to one of the spark plug and the spark plug wire.

5. The module as claimed in claim 1, wherein the sensor includes an inductive sensor that is removably connectable to one of the spark plug and the spark plug wire.

6. The module as claimed in claim 1, wherein the sensor includes an inductive sensor disposed adjacent the spark plug.

7. The module as claimed in claim 6, wherein the engine includes an ignition coil, and wherein the inductive sensor is connected to the ignition coil.

8. The module as claimed in claim 6, wherein the engine includes an ignition coil, and wherein the inductive sensor is disposed adjacent the ignition coil.

9. The module as claimed in claim 1, further comprising a communication port and a communication circuit operable to communicate with a computing device through the communication port.

10. The module as claimed in claim 1, wherein the digital signal is an indication of an ignition event.

11. The module as claimed in claim 1, further comprising a temperature sensor interconnected with the engine and operable to sense engine temperature.

12. The module as claimed in claim 1, further comprising a pressure sensor interconnected with the engine and operable to sense pressure.

13. The module as claimed in claim 1, further comprising an oil level sensor interconnected with the engine and operable to sense an oil level in the engine.

14. The module as claimed in claim 1, wherein the housing is removable from the equipment.

15. A system that determines operational characteristics of engine-driven power equipment, the equipment including an engine having a spark plug and a spark plug wire, the system comprising:
a data acquisition module including
a housing removably supportable on the equipment,
a sensor operable to sense an analog signal functionally related to a spark plug ignition signal,
an analog to digital (A/D) converter that converts the analog signal to a digital signal, and
a storage device that stores data corresponding to the digital signal; and
a remote computer device, including a computer program, operable to communicate with the data acquisition module.

16. The system as claimed in claim 15, further comprising a processor that computes an operational value of the equipment based upon the digital signal.

17. The system as claimed in claim 16, wherein the computer program receives the operational value and displays a graphical representation of the operational value.

18. The system as claimed in claim 17, wherein the operational value includes one of a speed value and a load value.

19. The system as claimed in claim 15, wherein the sensor includes a connector that is removably connectable to one of the spark plug and the spark plug wire.

20. The module as claimed in claim 15, wherein the sensor includes an inductive sensor that is removably connectable to one of the spark plug and the spark plug wire.

21. The system as claimed in claim 15, wherein the sensor includes an inductive sensor disposed adjacent the spark plug.

22. The module as claimed in claim 21, wherein the engine includes an ignition coil, and wherein the inductive sensor is connected to the ignition coil.

23. The system as claimed in claim 21, wherein the engine includes an ignition coil, and wherein the inductive sensor is disposed adjacent the ignition coil.

24. The system as claimed in claim 15, wherein the data acquisition module includes a communication port and a communication circuit operable to communicate with the remote computer device.

25. The system as claimed in claim 24, wherein the remote computer device includes a serial port, and wherein the data acquisition module and the remote computer device communicate through the serial port.

26. The system as claimed in claim 24, wherein the remote computer device and the data acquisition module communicate using infrared signals.

27. The system as claimed in claim 15, wherein the digital signal is an indication of an ignition event.

28. The system as claimed in claim 15, further comprising a temperature sensor interconnected with the engine and operable to sense engine temperature.

29. The system as claimed in claim 15, further comprising a pressure sensor interconnected with the engine and operable to sense pressure.

30. The system as claimed in claim 15, further comprising an oil level sensor interconnected with the engine and operable to sense an oil level in the engine.

31. The system as claimed in claim 15, wherein the computer program stores in memory, at least one of a parts list, a maintenance instructional manual, and a replacement parts list.

32. The system as claimed in claim 15, wherein the remote computer device is a wireless device.

33. The system as claimed in claim 15, wherein the remote computer device is a personal computer.

34. Engine-driven power equipment comprising:
a frame;
an engine supported by the frame, including a spark plug and a spark plug wire; and
a data acquisition module including
a removable housing;
a sensor operable to sense an analog signal functionally related to a spark plug ignition signal;
an analog to digital (A/D) converter that converts the analog signal to a digital signal; and
a storage device that stores data corresponding to the digital signal.

35. The equipment as claimed in claim 34, wherein the equipment is a lawnmower.

36. The equipment as claimed in claim 34, wherein the equipment is a generator.

37. The equipment as claimed in claim 34, wherein the module further comprises a processor that computes an operational value of the equipment based upon the digital signal.

38. The equipment as claimed in claim 34, wherein the sensor includes a connector that is removably connectable to the spark plug wire.

39. The equipment as claimed in claim 34, wherein the sensor includes an inductive sensor that is removably connectable to one of the spark plug and the spark plug wire.

40. The equipment as claimed in claim 34, wherein the sensor includes an inductive sensor disposed adjacent the spark plug.

41. The module as claimed in claim 40, wherein the engine includes an ignition coil, and wherein the inductive sensor is connected to the ignition coil.

42. The equipment as claimed in claim 40, wherein the engine includes an ignition coil, and wherein the inductive sensor is disposed adjacent the ignition coil.

43. The equipment as claimed in claim 34, further comprising a communication port and a communication circuit operable to communicate with a computing device through the communication port.

44. The equipment as claimed in claim 34, wherein the digital signal is an indication of an ignition event.

45. The equipment as claimed in claim 34, further comprising a temperature sensor interconnected with the engine and operable to sense engine temperature.

46. The equipment as claimed in claim 34, further comprising a pressure sensor interconnected with the engine and operable to sense pressure.

47. The equipment as claimed in claim 34, further comprising an oil level sensor interconnected with the engine and operable to sense an oil level in the engine.
